(19) United States
(12) Patent Application Publication
(10) Pub. No.: US 2019/0012077 A1
(43) Pub. Date: Jan. 10, 2019

(54) CHINESE CHARACTER INPUT APPARATUS AND CONTROLLING METHOD THEREOF

(71) Applicants: BENEDEA INC., Seoul (KR); Seoul National University R&DB Foundation, Seoul (KR)

(72) Inventors: Hyun-Kyung NOH, Seoul (KR); Kunsoo PARK, Seoul (KR); Hyunjoon KIM, Seongnam-si, Gyeonggi-do (KR)

(21) Appl. No.: 16/028,832

(22) Filed: Jul. 6, 2018

(30) Foreign Application Priority Data
Jul. 6, 2017 (KR) 10-2017-0085899

(51) Int. Cl. G06F 3/0488; G06F 17/22; G06F 3/0482

(52) U.S. Cl. CPC G06F 3/04886; G06F 3/0482; G06F 17/2223

(57) ABSTRACT

Provided is a Chinese character input apparatus and a controlling method thereof, in which the Chinese character input apparatus and the controlling method include inputting one or more middle units from a user, displaying, on a recommendation list window, a list of recommended Chinese characters comprising one or more Chinese characters that contain the inputted middle units, and displaying, on the input window, a Chinese character selected by the user from the list of recommended Chinese characters.

### CROSS-REFERENCE TO RELATED APPLICATIONS

This application claims the priority of Korean Patent Application No. 10-2017-0085899 filed on Jul. 6, 2017, in the Korean Intellectual Property Office, the disclosure of which is hereby incorporated by reference in its entirety.

### BACKGROUND

### 1. Technical Field

The present disclosure relates to a Chinese character input apparatus and a controlling method thereof.

### 2. Description of the Related Art

Along with the recent developments in China, an increasing number of people want to learn Chinese characters or already use them. Unlike Hangul (Korean characters) or English alphabets which have a relatively simple character system and have a less number of characters. Chinese character (“Hanzi”) is the ideogram that includes a hieroglyph and has tens of thousands of characters. Therefore, it is impossible to input Chinese character directly by using a limited number of keyboards of an electronic device such as a computer, a mobile phone, and so on, and it is thus extremely difficult to input Chinese character using the electronic device.

For a conventional method of inputting Chinese character, generally, pinyin input method (“pinyin”) and Wubizixing input method (“Wubi”) (i.e., five stroke character model input method) are most widely used.

First, the pinyin input method is a method of listing candidates of characters with the same pronunciation and selecting a character desired to input from among them. However, this method has a disadvantage in that it is necessary to input Chinese character in Roman characters even when a user knows the Chinese character to input, and that it is also difficult to input correct corresponding Chinese character when the user does not know the correct pronunciation. Also, when there are too many Chinese characters having the same pronunciation, there is a disadvantage in that it is difficult to input Chinese character quickly because it is necessary to select a character to input from among a large number of Chinese character groups having the same pronunciation in order to input one character.

Second, the Wubi input method is a method of constructing a Chinese character using a combination of strokes and radicals and inputting the resultant Chinese character. To use the Wubi input method, it is necessary to memorize the symbols and keys of the Wubi system, and also know the order of strokes and have skills to input the Wubi. When inputting Chinese character using the Wubi input method, it is possible to make a letter by typing mainly 4 keys, or typing 1 to 3 keys when it is a frequently-used word.

The Wubi input method has an advantage that it is possible to input Chinese character faster than pinyin input method for those who are accustomed to it. However, it also has a disadvantage that it is relatively more difficult to learn than pinyin input method. This is because some Chinese characters are so difficult to input intuitively that it is necessary to use the Wubi dictionary. Therefore, there is a disadvantage that a long time training is required to input Chinese character with the Wubi input method.

As a result, a new Chinese character input method is required, which is capable of inputting a Chinese character faster than pinyin input method, and which is easier to input and is more intuitive than Wubi input method.

### SUMMARY

An object of the present disclosure is to provide a Chinese character input method capable of inputting a Chinese character quickly and easily by inputting a base unit that does not use the pronunciation of Chinese character.

It is another object of the present disclosure to provide a Chinese character input method which allows a user who does not know the order of strokes of Chinese character to easily input Chinese character by an intuitive base unit inputting, without requiring a user to spend a long period of time to learn how to input.

The objects of the present disclosure are not limited to the objects mentioned above, and other objects and advantages of the present disclosure which are not mentioned can be understood by the description below and more clearly understood by the embodiments of the present disclosure. It is to be easily understood that the objects and advantages of the present disclosure can be realized by the means shown in the claims and combinations thereof.

In order to accomplish the above object, an embodiment of the present disclosure includes inputting one or more middle units from a user, displaying, on a recommendation list window, a list of recommended Chinese characters comprising one or more Chinese characters that contain the inputted middle units, and displaying, on the input window, a Chinese character selected by the user from the list of recommended Chinese characters.

According to another aspect of the present disclosure, an embodiment includes an input unit for inputting one or more middle units from a user, a recommendation list generator for generating a list of recommended Chinese characters comprising one or more Chinese characters that contain the inputted middle units, and a display unit for displaying, on a recommendation list window, the list of recommended Chinese characters and displaying, on the input window, a Chinese character selected by the user from the list of recommended Chinese characters.

According to the embodiments as described above, it is possible to provide a Chinese character input method capable of quickly and easily inputting Chinese character by inputting a base unit that does not use pronunciation of Chinese character.

Further, according to the embodiments of the present disclosure, there is an advantage that a Chinese character input method is provided, which allows a user who does not know the order of strokes of Chinese character to easily input Chinese character by an intuitive base unit inputting, without having to learn how to input for a long time.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram showing a schematic configuration of a Chinese character input apparatus according to an embodiment of the present disclosure:

FIG. 2 illustrates an embodiment of a screen of a Chinese character input apparatus which is a smart-phone:

FIG. 3 illustrates an embodiment of a virtual keyboard including a base unit button;

FIG. 4 illustrates an embodiment in which a list of recommended middle units is generated based on a base unit;

FIG. 5 illustrates an embodiment of generating a list of recommended middle units upon direct input of a basic middle unit;

FIG. 6 illustrates an embodiment in which an order of inputting a base unit is not taken into consideration in the generation of the list of recommended middle units:

FIG. 7 illustrates an embodiment in which a previously-inputted middle unit is taken into consideration in the generation of a list of recommended middle units;

FIG. 8 illustrates an embodiment in which a list of recommended Chinese characters is generated based on a middle unit:

FIG. 9 illustrates an embodiment in which an order of inputting a middle unit is not taken into consideration in the generation of the list of recommended Chinese character;

FIG. 10 illustrates an embodiment in which a list of recommended words is generated based on a Chinese character; and

FIG. 11 illustrates an embodiment showing representation of a complete state and incomplete state of a Chinese character.

### DETAILED DESCRIPTION

The above objects, features and advantages will be described in detail below with reference to the accompanying drawings to facilitate those skilled in the art to easily implement the technical concept of the present disclosure. In the below description of the present disclosure, a detailed description of known functions and configurations incorporated herein will be omitted when it may make the subject matter of the present disclosure rather unclear. Hereinafter, preferred embodiments according to the present disclosure will be described in detail with reference to the accompanying drawings. In the drawings, the same reference numerals are used for indicating the same or similar elements.

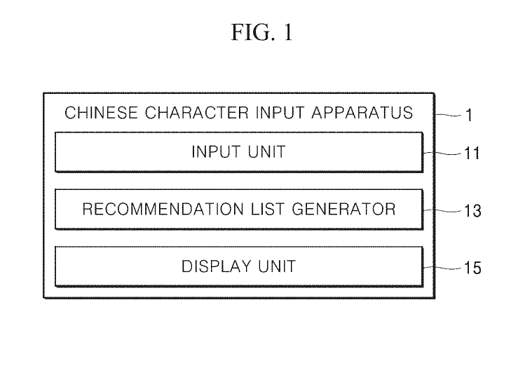

FIG. 1 is a block diagram showing a schematic configuration of a Chinese character input apparatus according to an embodiment of the present disclosure.

Referring to FIG. 1, a Chinese character input apparatus 1 according to an embodiment of the present disclosure includes an input unit 11, a recommendation list generator 13, and a display unit 15.

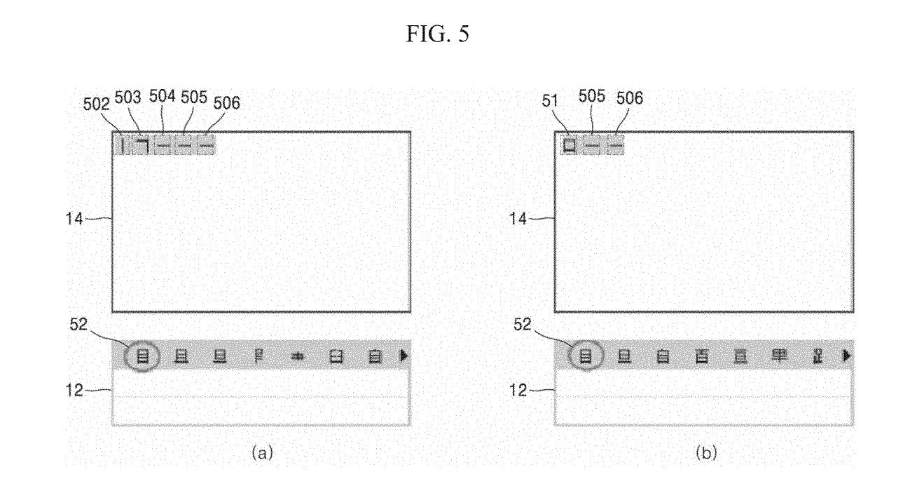

The input unit 11 receives one or more base units, middle units, Chinese characters, or words from a user. In this example, one or more middle units that the input unit 11 receives from the user include a basic middle unit to be described below with reference to FIG. 5.

In the present disclosure, the ‘base unit’ means a smallest unit of a Chinese character. Therefore, the Chinese character may be generated through a combination of one or more base units, and in the present disclosure, the user may input a base unit for generating Chinese character through the input unit 11. Table 1 below lists base units that may be inputted to the Chinese character input apparatus 1 according to an embodiment of the present disclosure.

TABLE 1

| | | | | | | | | | | | | | | | | | | | |
|---|---|---|---|---|---|---|---|---|---|---|---|---|---|---|---|---|---|---|---|
| 1 | [symbol] | 2 | [symbol] | 3 | [symbol] | 4 | [symbol] | 5 | [symbol] | 6 | [symbol] | 7 | [symbol] | 8 | [symbol] | 9 | [symbol] | 10 | [symbol] |
| 11 | [symbol] | 12 | [symbol] | 13 | [symbol] | 14 | [symbol] | 15 | [symbol] | 16 | [symbol] | 17 | [symbol] | 18 | [symbol] | 19 | [symbol] | 20 | [symbol] |
| 21 | [symbol] | 22 | [symbol] | 23 | [symbol] | 24 | [symbol] | 25 | [symbol] | 26 | [symbol] | | | | | | | | |

In the present disclosure, a Chinese character input method using a combination of base units includes an intermediate process of generating a middle unit. A ‘middle unit’ used herein refers to a basic unit of a Chinese character that may be generated through a combination of one or more base units. The middle unit may include the radicals of Chinese characters, and the middle unit itself may be Chinese character. That is, a middle unit may be generated through a combination of one or more base units, and a Chinese character may be generated through a combination of one or more middle units.

The recommendation list generator 13 generates a list of recommended middle units, a list of recommended Chinese characters, or a list of recommended words based on the base unit, the middle unit, or the Chinese character inputted from the user.

The display unit 15 displays a base unit, a middle unit, a Chinese character, or a word inputted by the user on the input window, and displays, on a recommendation list window, a list of recommended middle units, a list of recommended Chinese characters, or a list of recommended words generated by the recommendation list generator 13.

In one embodiment of the present disclosure, the Chinese character input apparatus 1 may be an electronic device such as a computer or a smart-phone, and the method of the input unit 11 for receiving a base unit from a user and the method of the display unit 15 for displaying the base unit and the like on an input window and displaying a list of recommended middle units and the like on a recommendation list window may vary depending on the type of electronic device that constitute the Chinese character input apparatus 1.

For example, when the Chinese character input apparatus 1 is a computer, the input unit 11 may receive a base unit, and so on by typing on a keyboard connected to the computer or a mouse click from a user. At this time, the display unit 15 may transmit visual information to the user through an external display device such as a monitor, and so on connected to the computer.

In the present disclosure, the visual information transmitted to the user by the display unit 15 may include all information required by the user to input Chinese character. Particularly, the visual information may include information on a base unit, a middle unit, a Chinese character, or a word that may be displayed by the display unit 15 to be described below on an input window, a recommendation list window, and so on.

In another embodiment, when the Chinese character input apparatus 1 is a smart-phone, the input unit 11 and the display unit 15 may receive the base unit and so on and transmit the visual information through one touch screen. That is, the input unit 11 may receive a base unit and so on by a touch of a user on the touch screen, and the display unit 15 may transmit the visual information to the user through the touch screen.

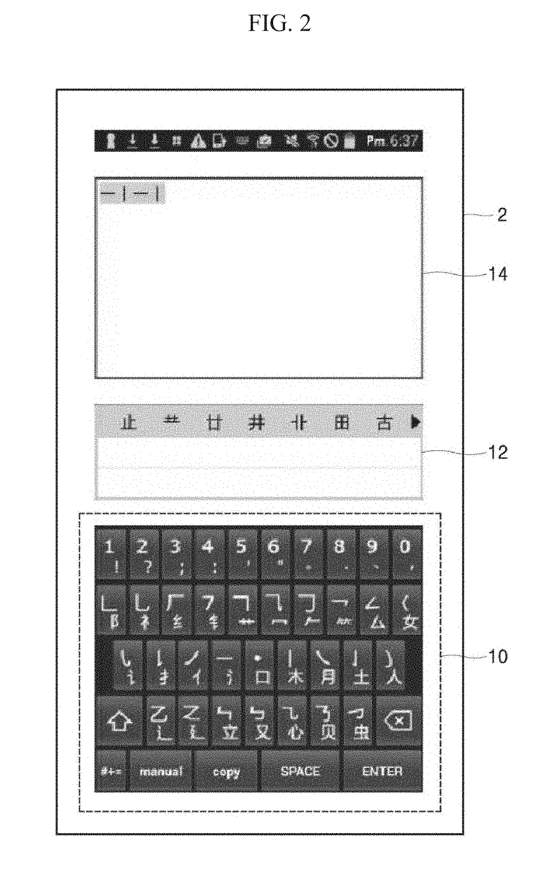

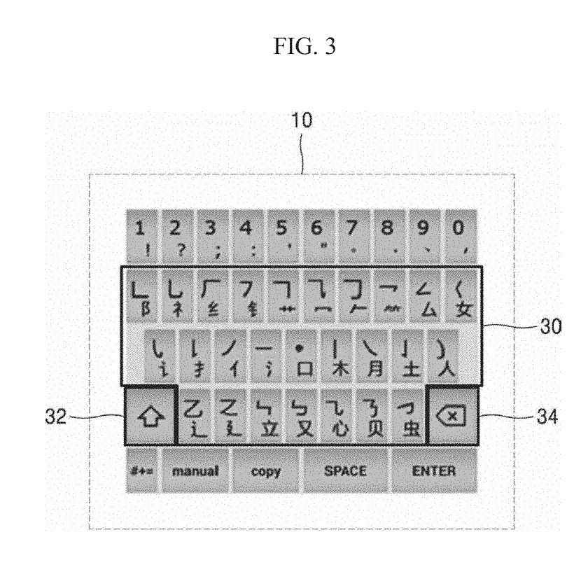

Hereinafter, by referring to FIGS. 2 and 3, a method of inputting a base unit and so on to the input unit through the Chinese character input apparatus of the present disclosure will be described in detail.

FIG. 2 illustrates an embodiment of a screen of a Chinese character input apparatus.

As described above, the Chinese character input apparatus according to an embodiment of the present disclosure may be a smart-phone, and the screen of the Chinese character input apparatus may be a touch screen included in the smart-phone. At this time, the input unit and the display unit may each receive a base unit and transmit the visual information through one touch screen.

FIG. 2 illustrates an example of the touch screen 2 included in the smart-phone constituting the Chinese character input apparatus. In one embodiment of the present disclosure, the touch screen 2 of the Chinese character input apparatus, which is a smart-phone, may display a virtual keyboard 10, a recommendation list window 12, and an input window 14. The user may input a base unit or a basic middle unit to the input unit with a touch on the virtual keyboard 10. The display unit may display a base unit, a middle unit, a Chinese character or a word inputted by the user on the input window 14, and may display on the recommendation list window 12 a list of recommended middle units, a list of recommended Chinese characters, or a list of recommended words generated by the recommendation list generator.

Referring again to FIG. 2, the virtual keyboard 10 may include buttons displaying respective base units that the user may input. The user may touch the buttons included in the virtual keyboard 10 to input a base unit, while confirming the content displayed on the input window 14 and the recommendation list window 12.

FIG. 3 illustrates an embodiment of a virtual keyboard including a base unit button.

Referring to FIG. 3, the virtual keyboard 10 according to an embodiment of the present disclosure may include a base unit button 30, a switch button 32, and a delete button 34.

The base unit button 30 may be composed of a plurality of buttons displaying multiple base units for inputting Chinese characters. Referring again to FIG. 3, the base unit button 30 may display all the base units included in Table 1 on an upper side of each button. That is, the user may input all base units that may be inputted to the Chinese character input apparatus by pressing each base unit button 30 and thus inputting the base unit displayed on the upper side of each button.

The input unit 11 may directly receive one or more basic middle units of the basic middle units previously-set by the user through the keyboard.

Referring again to FIG. 3, the base unit button 30 may be composed of buttons having a plurality of previously-set basic middle units displayed thereon in addition to the base units. In the present disclosure, the ‘basic middle unit’ means a middle unit pre-designated so as to be directly inputted to the Chinese character input apparatus like the base unit.

In one embodiment of the present disclosure, a plurality of previously-set basic middle units displayed on each of the base unit buttons may be composed of middle units frequently used by the user. The user may input the basic middle unit displayed on a lower side of each base unit button in addition to the base unit displayed on the upper side of each base unit button, by pressing each base unit button 30 according to a previously-set method.

For example, the user may input the basic middle unit displayed on a lower side of each base unit button by pressing each base unit button 30 for a previously-set threshold time or longer. In another example, the user may input the basic middle unit displayed on a lower side of each button by pressing the switch button 32 and then pressing the base unit button 30.

The user may input a plurality of previously-set basic middle units through the respective base unit buttons 30, thereby reducing the time required for inputting the Chinese character. This will be described in detail below with reference to FIG. 5.

In an embodiment of the present disclosure, the user may press the base unit button 30 to input a base unit, and may press the delete button 34 to cancel the base unit input. Likewise, even when the user presses the base unit button 30 to thus input the basic middle unit, the user may cancel the input of the basic middle unit by pressing the delete button 34.

The user may press the delete button 34 to cancel the input of the middle unit, Chinese character, or word also in the case of having inputted the middle unit, Chinese character, or word is inputted through the list of recommended middle units, the list of recommended Chinese characters, or the list of recommended words, which will be described below.

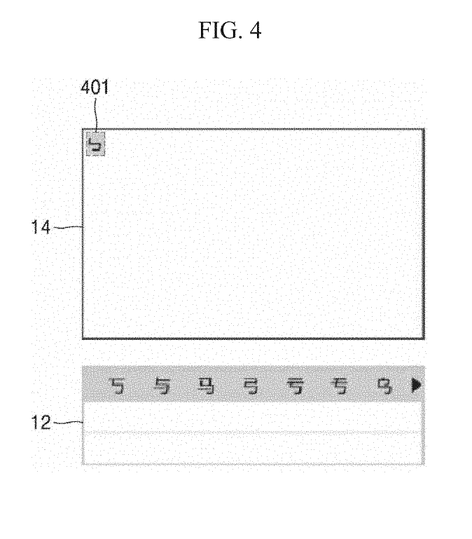

Hereinafter, the process at the Chinese character input apparatus of the present disclosure for generating a list of recommended middle units based on the base unit or basic middle unit inputted by the user, and receiving from the user a middle unit selected from the list of recommended middle units will be described in detail with reference to the FIGS. 4 to 7.

As described above, when the user inputs a base unit or a basic middle unit to the input unit, the display unit displays on the input window the base unit or basic middle unit inputted by the user. The recommendation list generator generates a list of recommended middle units based on the base unit or the middle unit inputted by the user. Thereafter, the display unit displays a list of recommended middle units generated by the recommendation list generator on the recommendation list window.

FIG. 4 illustrates an embodiment in which a list of recommended middle units is generated based on a base unit.

The user may input the first base unit 401 to the input unit. The first base unit 401 inputted by the user is displayed on the input window 14. At this time, the recommendation list generator generates a list of recommended middle units, which is a list of the middle units that contains the first base unit 401. In this example, when the middle unit includes the first base unit 401, it means that the middle unit is the one that can be formed by using the first base unit 401 alone or by a combination with one or more other base units. The list of recommended middle units generated by the recommendation list generator is displayed on the recommendation list window 12.

The user may select the middle unit from the list of recommended middle units displayed on the recommendation list window 12 and input the selected middle unit to the input unit.

When the user completes selecting the middle unit, instead of the first base unit 401 displayed previously, a middle unit newly inputted by the user's selecting may be displayed on the input window 14. The selected middle unit displayed on the input window 14 as described above is used for generating a list of recommended Chinese characters to be described below.

In one embodiment of the present disclosure, the user may select the same middle unit multiple times on the recommendation list window 12 and input them consecutively. At this time, the middle unit selected by the user is displayed on the input window 14 by the number of times selected by the user. For example, the user may input same middle unit twice in succession by double-clicking or double-touching the middle unit displayed on the recommendation list window.

FIG. 5 illustrates an embodiment of generating a list of recommended middle units upon direct input of a basic middle unit.

As described above, the user may input a previously-set basic middle unit through the base unit button 30. At this time, a list of recommended middle units composed of one or more middle units including the inputted basic middle unit may be displayed on the recommendation list window 12. That is, the user may directly input the basic middle unit through the base unit button 30, rather than pressing the base unit button 30 multiple times and generating a list of recommended middle units, thereby saving time required for inputting the Chinese character.

In FIG. 5, (a) illustrates an example in which the user inputs a second base unit 502, a third base unit 503, a fourth base unit 504, a fifth base unit 505 and a sixth base unit 506 in order. At this time, the second to sixth base units 502 to 506 inputted by the user may be displayed on the input window 14 in the order of input and a list of recommended middle units composed of one or more middle units including all of the second to sixth base units 502 to 506 may be displayed on the recommendation list window 12. At this time, the list of recommended middle units displayed on the recommendation list window 12 includes the second recommended middle unit 52.

In FIG. 5, (b) illustrates an example in which the user inputs the first middle unit 51, the fifth base unit 505 and the sixth base unit 506 in order. In this example, the first middle unit 51 is a basic middle unit that may be generated by a combination of the second base unit 502, the third base unit 503, and the fourth base unit 504 described above. Likewise in (a), the first middle unit 51, the fifth base unit 505 and the sixth base unit 506 inputted by the user may be displayed on the input window 14 in the order of input, and a list of recommended middle units composed of one or more middle units including all of the first middle unit 51, the fifth base unit 505 and the sixth base unit 506 may be displayed on the recommendation list window 12. At this time, the list of recommended middle units displayed on the recommendation list window 12 includes the second recommended middle unit 52.

When comparing (a) and (b) in FIG. 5, all of the list of recommended middle units displayed on the recommendation list window 12 include the second recommended middle unit 52. That is, instead of inputting the second base unit 502, the third base unit 503, and the fourth base unit 504, respectively, the user may directly input the first middle unit 51 which may be generated by a combination of the second base unit 502, the third base unit 503, and the fourth base unit 504 to generate the same list of recommended middle units.

As described above, the user may directly input the basic middle unit of the frequently used middle unit, without selecting and inputting the middle unit from the list of recommended middle units generated by a combination of a plurality of base units, thereby saving the time required for inputting the Chinese character.

In one embodiment of the present disclosure, the order of inputting a plurality of base units does not affect the result of the generation of the list of recommended middle units.

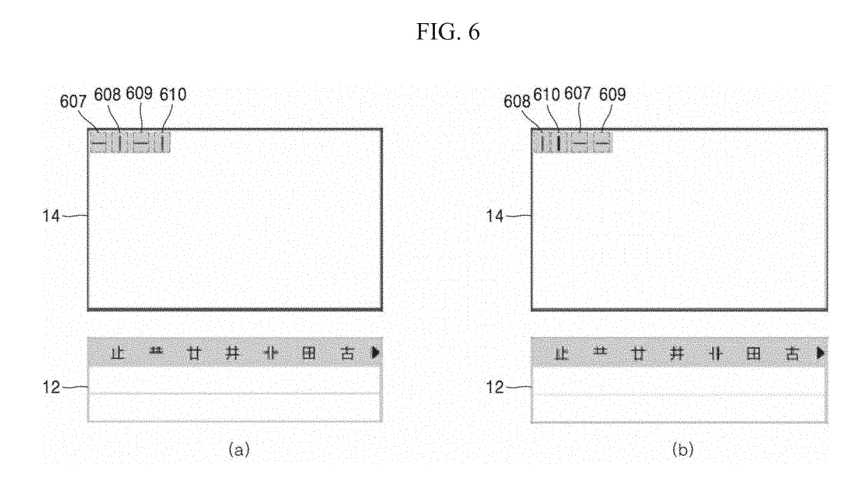

FIG. 6 illustrates an embodiment in which an order of inputting a base unit is not taken into consideration in the generation of the list of recommended middle units.

FIG. 6A illustrates an example in which the user inputs a seventh to tenth base units 607 to 610 in the order of the seventh base unit 607, the eighth base unit 608, the ninth base unit 609, and the tenth base unit 610. At this time, the seventh to tenth base units 607 to 610 inputted by the user may be displayed on the input window 14 in the order of input, and a list of recommended middle units composed of one or more middle units including all of the seventh to tenth base units 607 to 610 may be displayed on the recommendation list window 12.

FIG. 6B illustrates an example in which the user inputs the seventh to tenth base units 607 to 610 in the order of the eighth base unit 608, the tenth base unit 610, the seventh base unit 607, and the ninth base unit 609. Likewise FIG. 6A, the seventh to tenth base units 607 to 610 inputted by the user may be displayed on the input window 14 in the order of input, and a list of recommended middle units composed of one or more middle units including all of the seventh to tenth base units 607 to 610 may be displayed on the recommendation list window 12.

When comparing the examples of FIGS. 6A and 6B, both of the examples display the same list of recommended middle units on the recommendation list window 12. That is, the recommendation list generator may always generate the same list of recommended middle units for the same one or more base unit input regardless of the order of inputting the base unit inputted from the user.

As described above, since the base unit is the smallest unit of a Chinese character, the order of inputting the base units has a similar meaning as the order of strokes of a Chinese character. The Chinese character input apparatus of the present disclosure has an advantage that it can always generate the same list of recommended middle units for the same one or more base units inputted in different orders from each other so that even a user who does not know the Chinese character's stroke order may also input Chinese character easily.

In one embodiment of the present disclosure, based on a Chinese character containing all the previously-inputted middle units as well as the middle units that contain one or more currently-inputted base units, the list of recommended middle units displayed on the recommendation list window may be constructed excluding the middle units that are not included in the Chinese character.

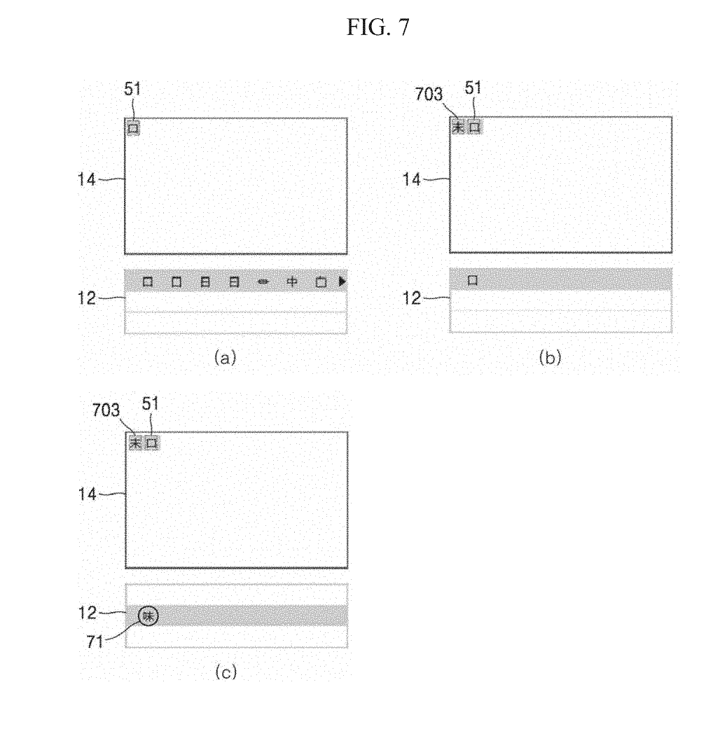

FIG. 7 illustrates an embodiment in which a previously-inputted middle unit is taken into consideration in the generation of a list of recommended middle units.

Referring to FIG. 7A, when a user directly inputs a first middle unit 51, which is a basic middle unit, a list of recommended middle units composed of middle units including the first middle unit 51 may be displayed on a recommendation list window 12. Although not shown in the drawing, as described above with reference to FIG. 5B, the user may input a second base unit 502, a third base unit 503, and a fourth base unit 504 instead of directly inputting the first middle unit 51 to obtain the same list of recommended middle units as when the first middle unit 51 is inputted.

Referring to FIG. 7B, after inputting the third middle unit 703, the user may further input the first middle unit 51 in a state in which the third middle unit 703 is being displayed on the input window 14. At this time, unlike the embodiment of FIG. 7A, the middle unit included in the list of recommended middle units displayed on the recommendation list window 12 is limited to a middle unit that can be combined with the third middle unit 703 to generate a Chinese character. Specifically, the list of recommended middle units generated by the recommendation list generator may be constructed such that middle unit not included in Chinese character is excluded from the list of recommended middle units, based on one or more Chinese characters including all of the previously-inputted third middle unit 703 and the first middle unit 51 as inputted.

For example, referring to FIG. 7C, there is only the first recommended Chinese character 71 present on the database, for a Chinese character that contains both of the third middle unit 703 and the first middle unit 51. Therefore, when the user inputs the first middle unit 51 which is the basic middle unit after inputting the third middle unit 703, as in the embodiment of FIG. 7A, a list of recommended middle units composed of middle units except the middle unit not included in the first recommended Chinese character 71 may be displayed, rather than displaying on the recommendation list window 12 all the recommended middle units that contain the first middle unit 51.

That is, since the recommendation list generator of the Chinese character input apparatus of the present disclosure provides the list of recommended middle units generated in consideration of the already-inputted middle units, there is an advantage that it is enabled to prevent a plurality of middle units, which may not generate a Chinese character in combination, from being inputted, so that the speed of inputting the Chinese character can be increased.

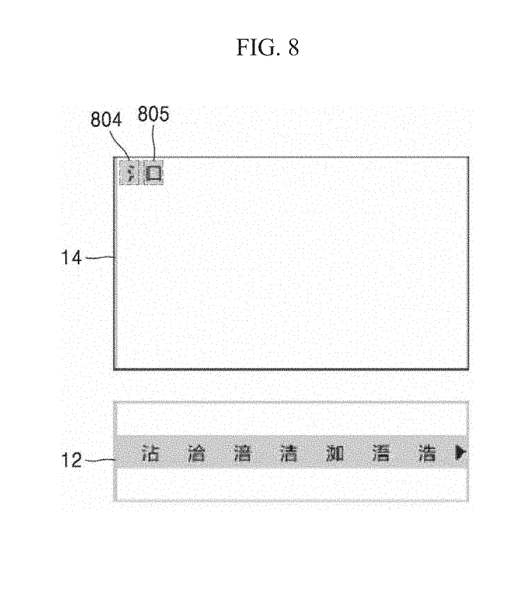

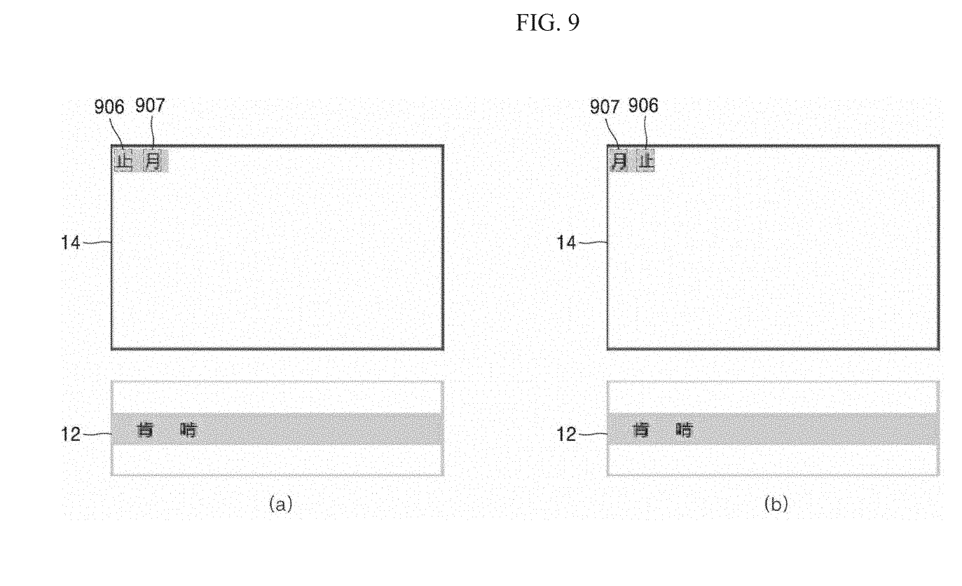

Hereinafter, the process at the Chinese character input apparatus of the present disclosure for generating a list of recommended Chinese characters based on a middle unit inputted from the user, and receiving from the user a Chinese character selected from the list of recommended Chinese characters will be described in detail with reference to the FIGS. 8 and 9.

As described above, when the user inputs a middle unit into the input unit, the display unit displays the middle unit inputted by the user on the input window. The recommendation list generator generates a list of recommended Chinese characters based on the middle units received from the user. Thereafter, the display unit displays a list of recommended Chinese characters generated by the recommendation list generator on the recommendation list window.

FIG. 8 illustrates an embodiment in which a list of recommended Chinese characters is generated based on a middle unit.

The user may input the fourth middle unit 804 and the fifth middle unit 805 to the input unit. At this time, the recommendation list generator generates a list of recommended Chinese characters composed of one or more Chinese characters that contain both of the fourth middle unit 804 and the fifth middle unit 805. In this example, by the statement “Chinese character including both of the fourth middle unit 804 and the fifth middle unit 805”, it means a Chinese character that can be constructed with only the fourth middle unit 804 and the fifth middle unit 805, or by a combination of the fourth middle unit 804 and the fifth middle unit 805 with one or more other middle units. The list of recommended Chinese characters generated by the recommendation list generator is displayed on the recommendation list window 12.

The user may select the Chinese character from the list of recommended Chinese characters displayed on the recommendation list window 12 and input the selected Chinese character to the input unit.

When the user completes selecting the Chinese character, instead of the fourth middle unit 804 and the fifth middle unit 805 displayed previously, a Chinese character newly inputted by the user's selecting may be displayed on the input window 14. The selected Chinese character displayed on the input window 14 as described above is used for generating a list of recommended words which will be described below.

In one embodiment of the present disclosure, the user may select the same Chinese character multiple times on the recommendation list window 12 and input them consecutively. At this time, the Chinese character selected by the user is displayed on the input window 14 by the number of times selected by the user. For example, a user may input the same Chinese character twice in succession by double-clicking or double-touching the Chinese character displayed on the recommendation list window.

In one embodiment of the present disclosure, the order of inputting a plurality of middle units does not affect the result of generating the list of recommended Chinese characters.

FIG. 9 illustrates an embodiment in which an order of inputting a middle unit is not taken into consideration in the generation of the list of recommended Chinese character.

FIG. 9A illustrates an example in which the user inputs the sixth middle unit 906 and the seventh middle unit 907 in the order of the sixth middle unit 906 and the seventh middle unit 907. At this time, the sixth middle unit 906 and the seventh middle unit 907 inputted by the user may be displayed on the input window 14 in the order of input and a list of recommended Chinese characters composed of one or more Chinese characters that contain both of the sixth middle unit 906 and the seventh middle unit 907 may be displayed on the recommendation list window 12.

FIG. 9B illustrates an example in which the user inputs the sixth middle unit 906 and the seventh middle unit 907 in the order of the seventh middle unit 907 and the sixth middle unit 906. Likewise FIG. 9A, the sixth middle unit 906 and the seventh middle unit 907 inputted by the user may be displayed on the input window 14 in the order of input, and a list of recommended Chinese characters composed of one or more Chinese character including both of the sixth middle unit 906 and the seventh middle unit 907 may be displayed on the recommendation list window 12.

When comparing the examples of FIGS. 9A and 9B, both of the examples display the same list of recommended Chinese characters on the recommendation list window 12. That is, the recommendation list generator may always generate the same list of recommended Chinese characters for the same one or more middle units being inputted, regardless of the order of inputting the middle units by the user.

The Chinese character input apparatus of the present disclosure has an advantage that it can always generate the same list of recommended Chinese characters for the same one or more middle units inputted in different orders from each other so that even a user who does not know the Chinese character's stroke order may also input Chinese character easily.

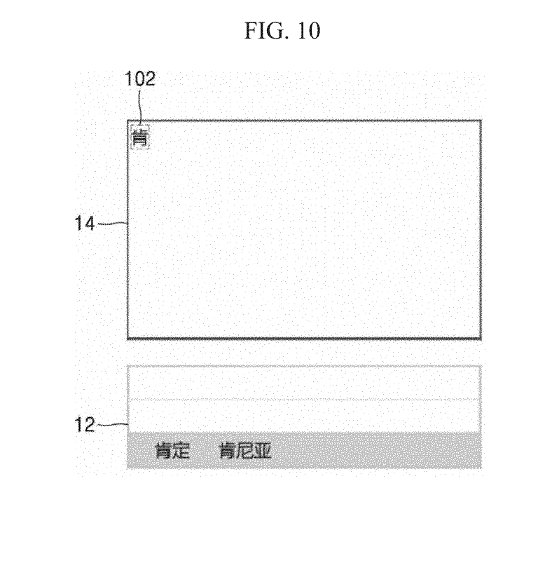

Hereinafter, the process at the Chinese character input apparatus of the present disclosure for generating a list of recommended words based on a Chinese character inputted from the user, and receiving from the user a word selected from the list of recommended words will be described in detail with reference to the FIG. 10.

As described above, when the user inputs a Chinese character into the input unit, the display unit displays the Chinese character inputted by the user on the input window. The recommendation list generator generates a list of recommended words based on the Chinese character received from the user. Thereafter, the display unit displays a list of recommended words generated by the recommendation list generator on the recommendation list window.

FIG. 10 illustrates an embodiment in which a list of recommended words is generated based on a Chinese character.

The user may input a second Chinese character 102 to the input unit. The second Chinese character 102 inputted by the user is displayed on the input window 14. At this time, the recommendation list generator generates a list of recommended words composed of one or more words that contain the second Chinese character 102. In this example, when the word includes the second Chinese character 102, it means that the word is the one that can be generated by combining the second Chinese character 102 with one or more other Chinese characters. The list of recommended words generated by the recommendation list generator is displayed on the recommendation list window 12.

The user may select the word from the list of recommended words displayed on the recommendation list window 12 and input the selected word to the input unit.

When the user completes selecting the word, instead of the second Chinese character 102 displayed previously, a word newly inputted by the user's selecting may be displayed on the input window 14.

In one embodiment of the present disclosure, the user may select the same word multiple times on the recommendation list window 12 and input them consecutively. At this time, the word selected by the user is displayed on the input window 14 by the number of times selected by the user. For example, a user may input the same word twice in succession by double-clicking or double-touching the word displayed on the recommendation list window.

In one embodiment of the present disclosure, a base unit or middle unit failed to be formed into a complete Chinese character may be displayed on the input window 14, distinctively from the completed Chinese character.

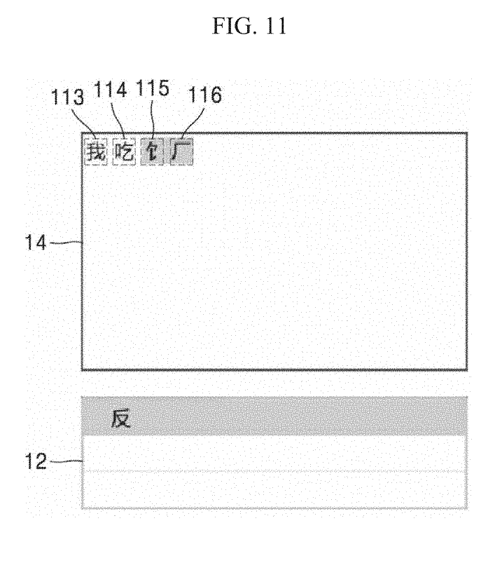

FIG. 11 illustrates an embodiment showing representation of a complete state and incomplete state of a Chinese character.

In the present disclosure, the complete state of the Chinese character means a state in which the Chinese character selected from the list of recommended Chinese characters by the user is displayed on the input window. Conversely, the incomplete state of the Chinese character means a state in which one or more base units or middle units are displayed on the input window before selecting of the Chinese character by the user from the list of recommended Chinese characters.

For example, referring to FIG. 11, the user may further input the eighth middle unit 115 and the eleventh base unit 116 in the state in which the third Chinese character 113 and the fourth Chinese character 114 are inputted to the input unit. First, the third Chinese character 113 and the fourth Chinese character 114 inputted previously may be displayed on the input window 14 together with the eighth middle unit 115 and the eleventh base unit 116. At this time, the eighth middle unit 115 and the eleventh base unit 116 may be displayed on the input window 14 with shading to be distinguished from the third Chinese character 113 and the fourth Chinese character 114 which are previously inputted.

Referring again to FIG. 11, as described above, when the eighth middle unit 115 and the eleventh base unit 116 are further inputted, regardless of the third Chinese character 113 and the fourth Chinese character 114, a list of recommended middle units composed of one or more middle unit that contain both of the eighth middle unit 115 and the eleventh base unit 116 is displayed on the recommendation list window 12.

Therefore, since the user of the Chinese character input apparatus of the present disclosure is able to distinguish and identify the base unit or the middle unit to construct a new Chinese character intended to be inputted from the previously-inputted Chinese character, it is possible to input the Chinese character accurately and quickly.

Chinese character input apparatus 1 according to an embodiment of the present disclosure may further include a memory. Memory can include high-speed random access memory or non-volatile memory, such as one or more magnetic disk storage devices, one or more optical storage devices, or flash memory (e.g., NAND, NOR). Memory can store an operating system, such as Darwin, RTXC, LINUX, UNIX, OS X, WINDOWS, or an embedded operating system such as VxWorks. The operating system may include instructions for handling basic system services and for performing hardware dependent tasks. In some implementations, the operating system can include a kernel (e.g., UNIX kernel).

Memory may also store communication instructions to facilitate communicating with one or more additional devices, one or more computers or one or more servers. Communication instructions can also be used to select an operational mode or communication medium for use by the device, based on a geographic location (obtained by the GPS/Navigation instructions) of the Chinese character input apparatus 1. Memory may include graphical user interface instructions to facilitate graphic user interface processing, including the graphical user interfaces and processes; sensor processing instructions to facilitate sensor-related processing and functions; phone instructions to facilitate phone-related processes and functions; electronic messaging instructions to facilitate electronic-messaging related processes and functions; web browsing instructions to facilitate web browsing-related processes and functions; media processing instructions to facilitate media processing-related processes and functions; GPS/Navigation instructions to facilitate GPS and navigation-related processes and instructions; camera instructions to facilitate camera-related processes and functions; dictionary module; language model; keyboard module; and keyboard model. The memory may also store other software instructions for facilitating other processes, features and applications.

Each of the above identified instructions and applications can correspond to a set of instructions for performing one or more functions described above. These instructions need not be implemented as separate software programs, procedures, or modules. Memory can include additional instructions or fewer instructions. Furthermore, various functions of the mobile device may be implemented in hardware and/or in software, including in one or more signal processing and/or application specific integrated circuits.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to, communicate with, one or more mass storage devices for storing data files; such devices include magnetic disks, such as internal hard disks and removable disks; magneto-optical disks; and optical disks.

Storage devices suitable for tangibly embodying computer program instructions and data include all forms of non-volatile memory, including by way of semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a player, the features can be implemented on a computer having a display device, such as a CRT (cathode ray tube) or LCD (liquid crystal display) monitor for displaying information to the player. The computer can also have a keyboard and a pointing device such as a game controller, mouse or a trackball by which the player can provide input to the computer.

The features can be implemented in a computer system that includes a back-end component, such as a data server, that includes a middleware component, such as an application server or an Internet server, or that includes a front-end component, such as a client computer having a graphical user interface or an Internet browser, or any combination of them. The components of the system can be connected by any form or medium of digital data communication such as a communication network. Some examples of communication networks include LAN. WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed implementations can be implemented using an API. An API can define on or more parameters that are passed between a calling application and other software code (e.g., an operating system, library routine, function) that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A controlling method of a Chinese character input apparatus, the control method comprising:
inputting one or more middle units from a user;
displaying, on a recommendation list window, a list of recommended Chinese characters comprising one or more Chinese characters that contain the inputted middle units; and
displaying, on the input window, a Chinese character selected by the user from the list of recommended Chinese characters.

2. The controlling method of claim 1, wherein the displaying the list of recommended Chinese characters on the recommendation list window comprises displaying a same list of recommended Chinese characters for the one or more middle units inputted in different orders from each other.

3. The controlling method of claim 1, wherein the inputting the one or more middle units comprises:
inputting one or more base units from the user;
displaying, on the recommendation list window, a list of recommended middle units including one or more middle units that contain the one or more base units; and
displaying, on the input window, a middle unit selected by the user from the list of recommended middle units.

4. The controlling method of claim 3, wherein the displaying the list of recommended middle units on the recommendation list window comprises displaying a same list of recommended middle units for the one or more base units inputted in different orders from each other.

5. The controlling method of claim 3, wherein the list of recommended middle units comprises the one or more middle units that contain the one or more base units, except for a middle unit that is not included in one or more Chinese characters that contain both of a previously-inputted middle unit and the middle unit that contains the one or more base units.

6. The controlling method of claim 3, wherein the inputting the one or more middle units further comprises:
directly inputting through a keyboard one or more basic middle units of basic middle units previously-set by the user; and
displaying, on a recommendation list window, a list of recommended middle units comprising one or more middle units that contain the inputted basic middle unit.

7. The controlling method of claim 1, further comprising:
displaying, on a recommendation list window, a list of recommended words comprising one or more words that include Chinese characters displayed on the input window; and
displaying, on the input window, a word selected by the user from the list of recommended words,
wherein the displaying the list of recommended words on the recommendation list window comprises displaying a same list of recommended words for the Chinese characters displayed on the input window in different orders from each other.

8. The controlling method of claim 1, wherein the displaying, on the input window, a Chinese character selected by the user from the list of recommended Chinese characters comprises displaying the selected Chinese character on the input window by a number of times the Chinese character is selected from the list of recommended Chinese characters by the user.

9. The controlling method of claim 3, wherein the displaying, on the input window, a middle unit selected by the user from the list of recommended middle units comprises displaying the selected middle unit on the input window by a number of times the middle unit is selected by the user from the list of recommended middle units.

10. The controlling method of claim 7, wherein the displaying, on the input window, a word selected by the user from the list of recommended words comprises displaying the selected word on the input window by a number of times the word is selected by the user from the list of recommended words.

11. A Chinese character input apparatus, comprising: one or more hardware processors;
a non-transitory computer-readable medium storing instructions, which, when executed, are operable to cause the one or more processors to perform operations comprising:
inputting one or more middle units from a user;
displaying, on a recommendation list window, a list of recommended Chinese characters comprising one or more Chinese characters that contain the inputted middle units; and
displaying, on the input window, a Chinese character selected by the user from the list of recommended Chinese characters.

12. The Chinese character input apparatus of claim 11, wherein the displaying the list of recommended Chinese characters on the recommendation list window comprises displaying a same list of recommended Chinese characters for the one or more middle units inputted in different orders from each other.

13. The Chinese character input apparatus of claim 11, wherein the inputting the one or more middle units comprises:
inputting one or more base units from the user;
displaying, on the recommendation list window, a list of recommended middle units including one or more middle units that contain the one or more base units; and
displaying, on the input window, a middle unit selected by the user from the list of recommended middle units.

14. The Chinese character input apparatus of claim 13, wherein the displaying the list of recommended middle units on the recommendation list window comprises displaying a same list of recommended middle units for the one or more base units inputted in different orders from each other.

15. The Chinese character input apparatus of claim 13, wherein the list of recommended middle units comprises the one or more middle units that contain the one or more base units, except for a middle unit that is not included in one or more Chinese characters that contain both of a previously-inputted middle unit and the middle unit that contains the one or more base units.

16. The Chinese character input apparatus of claim 13, wherein the inputting the one or more middle units further comprises:
directly inputting through a keyboard one or more basic middle units of basic middle units previously-set by the user; and
displaying, on a recommendation list window, a list of recommended middle units comprising one or more middle units that contain the inputted basic middle unit.

17. The Chinese character input apparatus of claim 11, wherein the operations further comprising:
displaying, on a recommendation list window, a list of recommended words comprising one or more words that include Chinese characters displayed on the input window; and
displaying, on the input window, a word selected by the user from the list of recommended words,
wherein the displaying the list of recommended words on the recommendation list window comprises displaying a same list of recommended words for the Chinese characters displayed on the input window in different orders from each other.

18. The Chinese character input apparatus of claim 11, wherein the displaying, on the input window, a Chinese character selected by the user from the list of recommended Chinese characters comprises displaying the selected Chinese character on the input window by a number of times the Chinese character is selected from the list of recommended Chinese characters by the user.

19. The Chinese character input apparatus of claim 13, wherein the displaying, on the input window, a middle unit selected by the user from the list of recommended middle units comprises displaying the selected middle unit on the input window by a number of times the middle unit is selected by the user from the list of recommended middle units.

20. The Chinese character input apparatus of claim 17, wherein the displaying, on the input window, a word selected by the user from the list of recommended words comprises displaying the selected word on the input window by a number of times the word is selected by the user from the list of recommended words.
